(19) United States
(12) Patent Application Publication
(10) Pub. No.: US 2007/0157508 A1
(43) Pub. Date: Jul. 12, 2007

(54) Method of trapping mosquitoes

(76) Inventor: Yin-Kuang Chang, Taipei (TW)

Correspondence Address: LEONG C LEI, PMB # 1008, 1867 YGNACIO VALLEY ROAD, WALNUT CREEK, CA, 94598, US

(21) Appl. No.: 11/327,455

(22) Filed: Jan. 9, 2006

(51) Int. Cl. A01M 1/06; A01M 1/02

(52) U.S. Cl. 43/139; 43/107

(57) ABSTRACT

A method of trapping mosquitoes is disclosed. The method comprises the steps of preparing a mosquito bait composition which emits an odor similar to that produced from human body; installing a mosquito trapping device having a luring section, a mosquito trapping section and an electrical controlling section; placing the bait composition into a bait container of the trapping device to convert the bait composition into gaseous state via a heating within the trapping device, and maintaining a temperature by a temperature sensor to simulate the human odor and a human temperature to attract mosquitoes, and generating an air stream by a fan and in combination with a mosquito net such that the blades of the fan hit the mosquitoes and trap within the mosquito net.

### BACKGROUND OF THE INVENTION

(a) Technical Field of the Invention

The present invention relates to a method to trap mosquitoes, and in particular, a cocktail type method to trap mosquitoes, employing a mosquitoes bait composition and a mosquitoes trapping device.

(b) Description of the Prior Art

Mosquitoes are pest that cause many diseases such as Malaria, Meningitis, Dengue fever, West Nile Virus, Yellow fever, and Heartworm disease in dog, and other types of diseases in poultry originate from mosquito bites.

In the olden days, PDT is used to kill the mosquitoes, and it is very common, in many developing countries, mosquitoes coils are used. This method only chases away the mosquitoes and does not kill the mosquitoes. The air from burning mosquitoes coils is generally toxin and may not be healthy to human.

Another type of mosquito trapping device is the mosquito trapping lamp, but this lamp is not effective to mosquitoes which are not attracted to light. For instance, culex mosquito will only be attracted to light at 370 nm-374 nm in the evening or in the morning. However, the UV from the trapping lamp is not able to maintain the wavelength at this accuracy. The Aedes and Anopheles mosquitoes are only active in the day and the trapping lamp is not effective to trap these mosquitoes. Therefore, it is an object of the present invention to provide a method of trapping mosquitoes which can mitigate the above drawbacks.

### SUMMARY OF THE INVENTION

The primary purpose of the present invention is to provide a cocktail-type method of trapping mosquitoes comprising the steps of preparing a mosquito bait composition which emits an odor similar to that produced from human body; installing a mosquito trapping device having a luring section, a mosquito trapping section and an electrical controlling section; placing the bait composition into a bait container of the trapping device to convert the bait composition into gaseous state via a heating within the trapping device, and maintaining a temperature by a temperature sensor to simulate the human odor and a human temperature to attract mosquitoes, and generating an air stream by a fan and in combination with a mosquito net such that the blades of the fan hit the mosquitoes and trap within the mosquito net.

Yet still another object of the present invention to provide a method of trapping mosquitoes, wherein the mosquito bait composition is prepared from lactic acid, amino acid, sodium chloride, glycerin, acylglycerol, triacylglycerol, lipid acid, stearic acid, lipoprotein, cholesterol, cholesterol ester, steroid and wax.

A further object of the present invention is to provide a method of trapping mosquitoes, wherein the components of the mosquito bait composition are varied to trap different types of mosquitoes.

Still yet another object of the present invention is to provide a method of trapping mosquitoes, wherein the bait container within the mosquito trapping device is divided into two slots for containing a water soluble bait composition and an oil soluble bait composition and the bait compositions are heated to be vaporized into the air to lure mosquitoes.

Yet a further object of the present invention is to provide a method of trapping mosquitoes, wherein the water soluble bait composition and the oil soluble bait composition are added with an emulsifying agent to form an emulsion within a slot, and are heated to be vaporized into the air to lure mosquitoes.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing the method in accordance with the present invention.

FIG. 2 is a system diagram of the method in accordance with the present invention.

FIGS. 3A & 3B is a perspective view of the component of the device in accordance with the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

In accordance with the present invention, a mosquitoes bait composition is prepared. The composition provides an odor which is similar to that generates from human body, and the bait composition is obtained by mixing the following components include: lactic acid, amino acid, sodium chloride, glycerin, acylglycerol, triacylglycerol, lipid acid, stearic acid, lipoprofein, cholesterol, cholesterol ester, steroid and wax. These components are mixed in an appropriate proportion. In accordance with the present invention, a mosquitoes trapping device is employed, which includes one or more thermostat for heating the bait composition or maintaining the bait in a temperature ranging from 38 to 42° C. A small fan is mounted beside the bait composition such that the vortex of air formed between the fan and the bait composition will draw mosquitoes from all direction and be impacted by the blades of the fan. The killed mosquitoes are collected at the mosquito net of the mosquitoes trapping device.

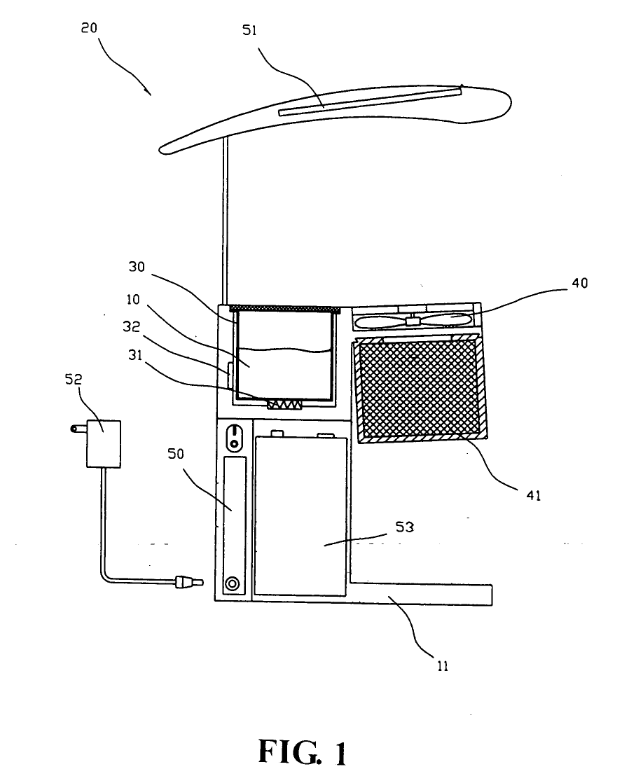

As shown in FIG. 1, the cocktail-type method of trapping mosquitoes employs a mosquito bait composition 10 and a mosquito trapping device 20. The trapping device 20 is divided into three sections, i.e., the mosquito a luring section, a mosquito trapping section, and an electrical control section.

In the mosquitoes luring section, a bait composition container 30 is placed within the body of the trapping device. The bottom section of the luring section is a heater 31 which heats up the mosquito bait composition into gaseous state and the temperature detector 32 adjusts the heating temperature such that the temperature is maintained at the best temperature to lure mosquitoes. In the mosquitoes trapping section, a fan 40 is mounted at an inclination angle, and the lower section of the fan is mounted with a mosquitoes collection net 41. The fan is closely mounted to the opening of the mosquito net and the rotation of the fan produces a vortex which attracts mosquitoes to be impacted by the blades of the fan. The killed mosquitoes are collected at the mosquito net of the trapping device.

The electrical control section is positioned at the lower section of the body of the trapping device, which includes a power source control IC board 50 as the control center of the mosquito trapping apparatus. The power supply is a low DC supply by conversion of AC source via a rectifier 52, or a solar energy plate 51 converts solar energy into electrical energy, and is supply as storage battery.

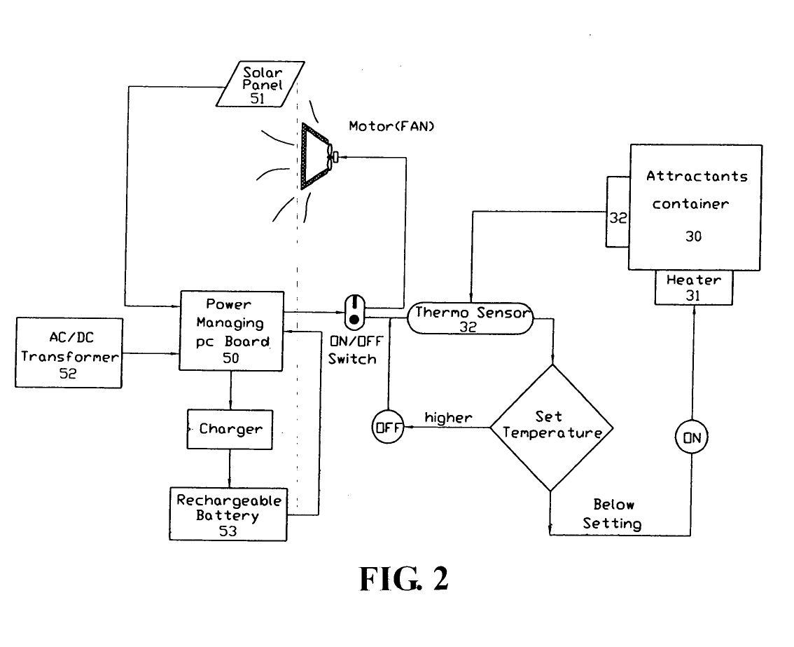

FIG. 2 is a flow chart in accordance with the present invention. When the switch of the trapping device 20 is on, the heater 31 heats up the bait container 30 and the bait composition 10 is changed into a vapor or gaseous state, which disperses from the center of the mosquito trapping center. The temperature detector 32 maintains the best temperature for luring mosquitoes. The control IC board 50 controls the switching of the fan 40, by either switching on intermittent or continuously, so that a vortex is formed. The vortex will draw mosquitoes into the trapping net 41. The blade of the fan will impact the mosquitoes and the killed mosquitoes are trapped within the trapping net.

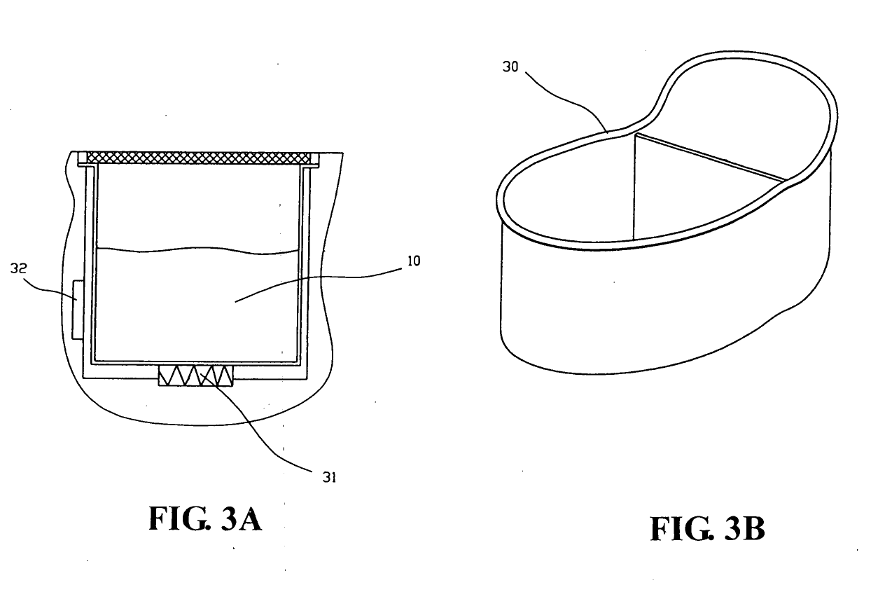

The bait container 30 has two slots (as shown in FIGS. 3A & 3B) for containing a water soluble and oil soluble bait composition. The composition is formed by mixing one or more than one mosquito bait liquids, or the oil and water soluble bait composition are added with an emulsifier and placed into the bait container. The heater vaporizes the composition which lures mosquitoes and kill by the blades of the fan.

The bait composition is varied in accordance with different types of mosquitoes, for instance, culex mosquitoes, 80% of the bait composition is oil soluble, i.e., glycerine, acylglycerol, triacylglycerol, lipid acid, stearic acid, lipoprotein, cholesterol, cholesterol ester, steroid and wax. In other words, the percentage of the component can be varied for a specific type of mosquito.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A cocktail-type method of trapping mosquitoes comprising the steps of
preparing a mosquito bait composition which emits an odor similar to that produced from human body;
installing a mosquito trapping device having a luring section, a mosquito trapping section and an electrical controlling section;
placing the bait composition into a bait container of the trapping device to convert the bait composition into gaseous state via a heating within the trapping device, and maintaining a temperature by a temperature sensor to simulate the human odor and a human temperature to attract mosquitoes, and
generating an air stream by a fan and in combination with a mosquito net such that the blades of the fan hit the mosquitoes and trap within the mosquito net.

2. The cocktail-type method of trapping mosquitoes of claim 1, wherein the mosquito bait composition is prepared from lactic acid, amino acid, sodium chloride, glycerin, acylglycerol, triacylglycerol, lipid acid, stearic acid, lipoprotein, cholesterol, cholesterol ester, steroid and wax.

3. The cocktail-type method of trapping mosquitoes of claim 1, wherein the components of the mosquito bait composition are varied to trap different types of mosquitoes.

4. The cocktail-type method of trapping mosquitoes of claim 1, wherein the bait container within the mosquito trapping device is divided into two slots for containing a water soluble bait composition and an oil soluble bait composition and the bait compositions are heated to be vapourized into the air to lure mosquitoes.

5. The cocktail-type method of trapping mosquitoes of claim 4, wherein the water soluble bait composition and the oil soluble bait composition are added with an emulsifying agent to form an emulsion within a slot, and are heated to be vaporized into the air to lure mosquitoes.
